(19) United States
(12) Patent Application Publication
(10) Pub. No.: US 2026/0343334 A1
(43) Pub. Date: Oct. 29, 2026

(54) SUPPORT OF LTM

(71) Applicant: LENOVO (BEIJING) LIMITED, Beijing (CN)

(72) Inventors: Bingchao LIU, Beijing (CN); Chenxi ZHU, Fairfax, VA (US); Lingling XIAO, Beijing (CN); Yi ZHANG, Beijing (CN); Wei LING, Beijing (CN)

(21) Appl. No.: 19/111,576

(22) PCT Filed: Feb. 14, 2023
(86) PCT No.: PCT/CN2023/075883

§ 371 Date: Mar. 13, 2025

(51) Int. Cl. H04W 36/00; H04W 36/08

(52) U.S. Cl. CPC H04W 36/0058; H04W 36/08

(57) ABSTRACT

Methods and apparatuses for support of LTM are disclosed. In one embodiment, a UE comprises a transceiver; and a processor coupled to the transceiver, wherein the processor is configured to receive, via the transceiver, a configuration for a CSI report, wherein, at least one of reference resources for channel measurement configured for the CSI report is associated with a candidate cell configuration; and transmit, via the transceiver, the CSI report including a measurement result of one or more candidate cells.

### FIELD

The subject matter disclosed herein generally relates to wireless communications, and more particularly relates to methods and apparatuses for support of L1/L2 triggered mobility (LTM).

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), base station (BS), layer 1 (L1), layer 2 (L2), layer 3 (L3), L1/L2 triggered mobility (LTM), Channel State Information (CSI), Channel State Information Reference Signal (CSI-RS), subcarrier spacing (SCS), synchronization signal (SS), Physical Broadcast Channel (PBCH), SS/PBCH Block (SSB), system frame number (SFN), quasi colocation (QCL), Physical resource block (PRB), channel measurement resource (CMR), reference signal (RS), bandwidth part (BWP).

Different from L3 based mobility, L1 measurements based on CSI reporting framework are used for LTM. It means that the UE can be configured to measure the quality of different candidate cells in layer 1 and report the measurement results of the candidate cells to the serving cell in one or more CSI reports. If the UE reports that one of the candidate cells is better than the current serving cell, the gNB can indicate a LTM command (e.g., in layer 2) to the UE to indicate the UE to switch to a candidate cell based on the measurement results. Both intra-frequency LTM and inter-frequency LTM are supported. For intra-frequency LTM, the candidate cells and the serving cell are in the same frequency. On the other hand, for inter-frequency LTM, the candidate cells are located in a frequency different from the frequency of the serving cell.

This invention targets behaviors of UE and gNB for LTM.

### BRIEF SUMMARY

Methods and apparatuses for support of LTM are disclosed.

In one embodiment, a UE comprises a transceiver; and a processor coupled to the transceiver, wherein the processor is configured to receive, via the transceiver, a configuration for a CSI report, wherein, at least one of reference resources for channel measurement configured for the CSI report is associated with a candidate cell configuration; and transmit, via the transceiver, the CSI report including a measurement result of one or more candidate cells.

In some embodiment, the processor is further configured to report, via the transceiver, a value of RF switching gap for each frequency or band combination for LTM.

In some embodiment, the processor is further configured to receive, via the transceiver, a configuration to configure a first RF switching gap and/or a second RF switching gap when the frequency of the reference resources for the CSI report is different from the frequency of any BWP of the serving cell. Each of the first RF switching gap and the second RF switching gap may be configured as a number of symbols with reference to SCS of the active BWP of the serving cell configuring or triggering the CSI report or of the BWP in which the CSI report is transmitted.

In some embodiment, each candidate cell configuration configures the parameters including at least one of center frequency of the SSB; subcarrier spacing of the SSB; subframe offset of candidate cell; periodicity of the SSB; SSB positions in a SSB burst; and transmit power of the SSB. When CSI-RS resources are configured as the reference resources, each candidate cell configuration may further configure one or more CSI-RS resources, or one or more CSI-RS resource set, each of which includes one or more CSI-RS resources, for LTM and configure the parameters for each CSI-RS resource including at least one of center frequency of the CSI-RS resource; subcarrier spacing of the CSI-RS resource; periodicity and slot offset of the periodic CSI-RS resource; QCL information of the CSI-RS resource; first OFDM symbol in the slot for transmission of the CSI-RS resource; RE position of the CSI-RS resource in a PRB; sequence for CSI-RS resource sequence initialization; density of the CSI-RS resource; transmit power offset of the CSI-RS resource relative to the transmit power of the SSB in the same candidate cell; and bandwidth of the CSI-RS resource, wherein, each CSI-RS resource is assumed to be a single-port CSI-RS resource.

In some embodiment, all the reference resources configured for the CSI report are in the same frequency.

In some embodiment, when the frequency of reference resources configured for the CSI report is covered by one or more configured BWPs of at least one serving cell, all the reference resources configured for the CSI report have the same SCS.

In some embodiment, when the frequency of reference resources configured for the CSI report are covered by one or more configured BWPs of at least one serving cell, the processor is further configured to receive, via the transceiver, a BWP switching command to switch DL RF of the UE to a BWP that covers the frequency of reference resources configured for the CSI report before receiving, via the transceiver, a first symbol of a first reference resource configured for the CSI report, wherein, the BWP has the same SCS as the SCS of the reference resources configured for the CSI report.

In some embodiment, the first RF switching gap is located before a DL slot determined as the CSI reference resource associated with the CSI report, and the second RF switching gap is located after the DL slot. In some other embodiment, the first RF switching gap is located before a first symbol of a first reference resource configured for the CSI report, and the second RF switching gap is located after a last symbol of a last reference resource configured for the CSI report.

In another embodiment, a method performed at a UE comprises receiving a configuration for a CSI report, wherein, at least one of reference resources for channel measurement configured for the CSI report is associated with a candidate cell configuration; and transmitting the CSI report including a measurement result of one or more candidate cells.

In still another embodiment, a base unit comprises a transceiver; and a processor coupled to the transceiver, wherein the processor is configured to transmit, via the transceiver, a configuration for a CSI report, wherein, at least one of reference resources for channel measurement configured for the CSI report is associated with a candidate cell configuration; and receive, via the transceiver, the CSI report including a measurement result of one or more candidate cells.

In yet another embodiment, a method performed at a base unit comprises transmitting a configuration for a CSI report, wherein, at least one of reference resources for channel measurement configured for the CSI report is associated with a candidate cell configuration; and receiving the CSI report including a measurement result of one or more candidate cells

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of CSI measurement for Scenario #1 in LTM according to a first sub-embodiment of a second embodiment;

FIG. 2 illustrates an example for CSI measurement and report for Scenario #2 for LTM according to a second sub-embodiment of the second embodiment;

FIG. 3 illustrates another example for CSI measurement and report for Scenario #2 for LTM according to a second sub-embodiment of the second embodiment;

FIG. 4 is a schematic flow chart diagram illustrating an embodiment of a method;

FIG. 5 is a schematic flow chart diagram illustrating an embodiment of another method; and

FIG. 6 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

A first embodiment relates to candidate cell configuration.

To support LTM, multiple candidate cells can be configured for the UE for L1 measurement. Each candidate cell may have a dedicate configuration, which can be referred to as candidate cell configuration. The candidate cell configuration has a configuration index, and configures the essential information for the candidate cell. The essential information may refer to the information necessary for the UE to perform L1 measurement.

An example of the candidate cell configuration is as follows:

```
CandidateCellConfig ::= SEQUENCE {
  CandidateCellConfigId
  ssbFrequency
  ssbSubcarrierSpacing
  SFNOffset
  ssbperiodicity
  ssb-PositionsInBurst
  ss-PBCH-BlockPower
  CSI-RS-RecouceSetForLTM SEQUENCE {
    CSI-RS-RecouceSetId
    CSI-RS-Resources SEQUENCE ( SIZE (1..maxNrofCSI-RS-
ResourcesPerSet)) OF NZP-CSI-RS-ResourceId
  }
    CSI-RS-Resources ::= SEQUENCE {
    CSI-RS-ResourceId
    CSI-RS-Frequency
    CSI-RS-SubcarrierSpacing
    slotConfig
    QCL-Info
    firstOFDMSymbolInTimeDomain
    frequency DomainAllocation
    sequenceGenerationConfig
    density
    powerControlOffsetSS
    bandwidth SEQUENCE {
      startPRB
      nofPRBS
    }
  }
```

It is assumed that SSB resources or CSI-RS resources can be configured as the channel measurement resources for beam measurement of the candidate cell for LTM. Since both intra-frequency LTM and inter-frequency LTM are supported for LTM, the center frequency and the SCS of the measurement resource, i.e., the SSB or CSI-RS resource, can be different from the center frequency and the SCS of the active BWP of the serving cell.

For each candidate cell configuration (CandidateCellConfig), a configuration index (CandidateCellConfigId) is included.

When SSB is configured for L1 measurement, at least one of the following SSB-related parameters may be included in the candidate cell configuration:
ssbFrequency: the center frequency of the SSB. Note that SSB is transmitted in a frequency range that is indicated by the center frequency of the frequency range.
ssbSubcarrierSpacing: the subcarrier spacing (SCS) of the SSB.
SFNOffset: the subframe number offset of the candidate cell with reference the current subframe number of the active BWP of the serving cell.
ssbperiodicity: the periodicity of the SSB.
ssb-PositionsInBurst: the SSB positions in a SSB burst. Each SSB burst consists of one or more SSBs.
ss-PBCH-BlockPower: the transmit power of the SSB, which is necessary if the transmit power of the CSI-RS resource is necessary to be obtained when CSI-RS resources are configured for candidate cell measurement.

When CSI-RS resources are configured for L1 measurement, the candidate cell configuration includes the CSI-RS-related parameters, in addition to the SSB-related parameters. Multiple CSI-RS resources or multiple CSI-RS resource sets (where each CSI-RS resource set may include one or multiple CSI-RS resources) for LTM measurements can be configured in each candidate cell configuration.

Each CSI-RS resource set can be identified by a CSI-RS resource set index (CSI-RS-RecouceSetId). Each CSI-RS resource can be identified by a CSI-RS resource index (CSI-RS-ResourceId).

For each CSI-RS resource, at least one of the following parameters can be configured:
CSI-RS-Frequency: the center frequency of the CSI-RS resource.
CSI-RS-SubcarrierSpacing: the subcarrier spacing (SCS) of the CSI-RS resource.
slotConfig: if the CSI-RS resource is periodic CSI-RS, the slotConfig indicates the periodicity and the slot offset of the periodic CSI-RS.
QCL-Info: each CSI-RS resource is QCLed with a SSB resource of the same candidate cell. The QCL-Info indicates a SSB in the same candidate cell for the UE to determine the spatial domain Rx filter for the CSI-RS resource, which can be referred to as QCL information of the CSI-RS resource.
firstOFDMSymbolInTimeDomain: the first OFDM symbol in the slot for transmission of the CSI-RS resource.
frequency DomainAllocation: the RE position of the CSI-RS resource in a PRB.
sequenceGenerationConfig: the sequence for CSI-RS resource sequence initialization.
density: the density of the CSI-RS resource, i.e., the number of REs for CSI-RS transmission in a PRB.
powerControlOffsetSS: the transmit power offset of the CSI-RS resource relative to the transmit power of the SSB in the same candidate cell.
bandwidth: the bandwidth of the CSI-RS resource. The ‘startPRB’ indicates the start PRB index of the CSI-RS resource. The ‘nofPRBS’ indicates the number of PRBs of the CSI-RS resource.

In addition, each CSI-RS resource is assumed to be a single-port CSI-RS resource.

In a CSI report configured for LTM, SSB or CSI-RS resources, each of which is associated with a candidate cell configuration index, can be configured as the channel measurement resource (CMR) of the CSI report.

It means that, when a UE receives a configuration of a CSI report including SSB or CSI-RS resources, each of which is associated with a candidate cell configuration index, configured as the channel measurement resource, the UE measures the channel measurement resource (i.e., the SSB or CSI-RS resources), and sends the measurement result of the candidate cells to the gNB in the CSI report. If a SSB or CSI-RS resource is configured without being associated with candidate cell configuration index, the UE assumes the SSB or CSI-RS resource is associated with the serving cell.

When the LTM is inter-frequency, which means that the frequency of the SSB or CSI-RS resources configured in the CMR is different from the frequency of the serving cell, a RF switching gap is necessary for the UE to switch its DL RF to the frequency of the SSB or CSI-RS resources configured in the CMR to receive and measure the SSB or CSI-RS resources.

A second embodiment relates to the RF switching gap.

LTM is performed based on CSI framework and the measurement gap used in L3 mobility is not needed. Compared with intra-frequency measurement, for inter-frequency measurement, the RF switching gap is needed for the UE to receive the configured SSB or CSI-RS resources in a frequency different from the frequency of serving cell.

For LTM, the UE shall firstly determine a slot for the reception of the configured SSB or CSI-RS resources of the candidate cells based on CSI reference resource framework and apply a RF switching gap before and optionally after the reception of the configured SSB or CSI-RS resources of the candidate cells to specify the UE and gNB behavior. The RF switching gap before the reception of the configured SSB or CSI-RS resources can be referred to as a first RF switching gap; and the RF switching gap after the reception of the configured SSB or CSI-RS resources can be referred to as a second RF switching gap. Therefore, the RF switching gap (the first RF switching gap and optionally the second RF switching gap) should be explicitly determined to specify the UE behavior in physical layer (i.e., layer 1).

The RF switching gap should be configured for the CSI report when the frequency of the SSB or CSI-RS resources configured for the CSI report is different from the frequency of the serving cell. It can be configured as X symbols or X ms, where X is a positive integer. The X symbols can be determined according to a reference SCS. The reference SCS may be determined by the active BWP of the serving cell configuring or triggering the CSI report, or by the BWP in which the CSI report is sent to the gNB. The first RF switching gap and the second RF switching gap may be separately configured. It means that the first RF switching gap may be configured as X1 symbols or X1 ms, where X1 is a positive integer; and the second RF switching gap may be configured as X2 symbols or X2 ms, where X2 is a positive integer.

If the UE supports inter-frequency LTM, it shall report the required RF switching gap for different frequency or band combinations, e.g., in capability reporting.

In CSI framework based L1 measurement, the UE shall determine a downlink slot n-n_{CSI-ref} to receive the SSB or CSI-RS resources associated with a CSI report, where

$$n = ⌊ {n}^{′} \cdot \frac{{2}^{{μ}_{DL}}}{{2}^{{μ}_{UL}}} ⌋ \cdot n ’$$

is the uplink slot in which the CSI report is reported (i.e., transmitted) to the gNB, and 2^{μ}^{_{DL}} and 2^{μ}^{_{UL}} are the subcarrier spacing configurations for DL and UL, respectively. n_{CSI-ref} is a predetermined number of slots.

Due to the frequency of the SSB or CSI-RS resources configured for the CSI report being different from the frequency of the serving cell in inter-frequency LTM, the UE should switch the DL RF to the frequency of the SSB or CSI-RS resources configured for the CSI report before the reception of SSB or CSI-RS resources configured for the CSI report, so that correct measurement results can be obtained.

There are two typical scenarios for inter-frequency mobility.
Scenario #1: The frequency of the SSB or CSI-RS resources configured for the CSI report is not covered by any of the active BWPs of SpCell and Scells configured for a UE but is covered by some (i.e., at least one) of the configured BWPs of SpCell and Scells configured for the UE. SpCell is the Primary cell of the master cell group (MCG) and/or the primary cell of the secondary cell group (SCG). Scell is the serving cells other than SpCell of MCG and/or SCG.
Scenario #2: The frequency of the SSB or CSI-RS resources configured for the CSI report is not covered by any of the configured BWPs of SpCell and Scells configured for a UE.

A first sub-embodiment of the second embodiment relates to Scenario #1.

For Scenario #1, the RF switching gap can be implemented by a BWP switching gap in view that the BWP switching gap can cover the RF switching gap. In detail, before the UE receives the SSB or CSI-RS resources configured for the CSI report, the UE expects to be indicated to switch to a configured BWP of SpCell or Scells configured for the UE that covers the frequency of the SSB or CSI-RS resources configured for the CSI report. Alternatively, the gNB can directly configure the UE to transmit the CSI report in a BWP of the SpCell and Scells configured for the UE that covers the frequency of the SSB or CSI-RS resources configured for the CSI report.

Besides, when the UL resource for the CSI report is in a BWP which doesn't cover the frequency of the SSB or CSI-RS resources configured for the CSI report (e.g., the CSI report will be transmitted in previously activated BWP), the gNB can further indicate the UE to switch the UL RF to frequency of the BWP containing the UL resource for the CSI report. Incidentally, in case of FDD, the DL RF switching does not affect the UL RF. It means that the UL RF switching may be unnecessary in FDD system.

To reduce the UE complexity, the first sub-embodiment proposes that the indicated BWP that covers the frequency of the SSB or CSI-RS resources configured for the CSI report has the same SCS and the same SFN offset as the SCS and the SFN offset for the SSB or CSI-RS resources configured for the CSI report.

An example of CSI measurement and report for Scenario #1 in LTM according to the first sub-embodiment is illustrated in FIG. 1. The UE is configured with a CSI report associated with a set of SSB resources associated with LTM candidate cells. The frequency of the SSBs is not covered by the active BWP #1 but is covered by BWP #2, which is inactive, of a serving cell. DL slot n−k (i.e., slot n−n_{CSI-ref}) is the slot in which the SSB resources associated with the CSI report are received by the UE. Before the UE receives the SSB resources associated with the CSI report, the gNB sends a DCI #1 in the active BWP #1 to the UE to switch the DL RF of the UE to BWP #2 to receive the SSB resources associated with the CSI report. If the CSI report including the measurement results is configured to be reported in an BWP different from the BWP for the reception of the SSB resources associated with the CSI report, e.g., the CSI report in FIG. 1 is indicated to be reported in BWP #1, the gNB can optionally further send another DCI (e.g., DCI #2) in BWP #2 to the UE after the UE receives the SSB resources associated with the CSI report, where DCI #2 indicates the UE to switch the UL RF to the BWP (e.g., BWP #1) for transmission of the CSI report, if the UL RF is changed due to the changed DL RF. In Scenario #1, the RF switching gap is covered by the BWP switching gap indicated by DCI #1 and optionally DCI #2. That is, a first RF switching gap before the reception of the SSB resources associated with the CSI report is covered by the BWP switching gap indicated by the TDRA field of DCI #1, and a second RF switching gap, if necessary, after the reception of the SSB resources associated with the CSI report is covered by the BWP switching gap indicated by DCI #2.

The SSB or CSI-RS resources for measurement configured in the CMR of the CSI report for LTM may be associated with different candidate cells. If the frequency of one of the SSB or CSI-RS resources is covered by another configured BWP of one serving cell, which is different from BWP #2, another BWP switching is required for receiving the corresponding SSB or CSI-RS resource. To simplify the gNB and UE complexity, the first sub-embodiment proposes to introduce the following restrictions:

All the frequency(ies) of the SSB or CSI-RS resources for measurement associated with a same CSI report should be covered by a same configured BWP of a serving cell.

All the SSB or CSI-RS resources for measurement associated with candidate cells have the same SCS.

The BWP that covers the frequency of the SSB or CSI-RS resources configured for the CSI report has the same SCS as the SCS for SSB or CSI-RS resources configured for the CSI report.

A second sub-embodiment of the second embodiment relates to Scenario #2.

For scenario #2, the UE requires an explicit RF switching gap to switch to the measurement frequency for reception of the SSB or CSI-RS resources configured for the CSI report. Similar to the first sub-embodiment related to scenario #1, the UE should complete the RF switching before the reception of the SSB or CSI-RS resources configured for the CSI report.

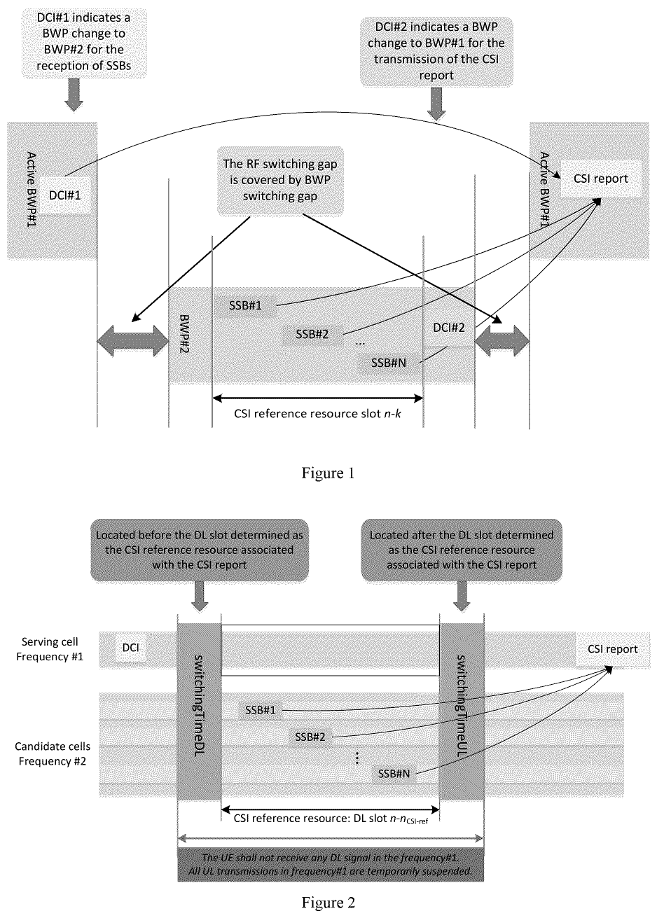

An example for CSI measurement and report for Scenario #2 for LTM according to the second sub-embodiment is illustrated in FIG. 2. The serving cell is in frequency #1 and the SSBs of some candidate cells are in another frequency #2. The gNB that manages the serving cell sends a DCI in the serving cell triggering a CSI report in uplink slot n′ (corresponding to downlink slot n) and the CSI report is associated with a set of SSB resources of candidate cells in frequency #2.

The UE firstly determines a CSI reference resource DL slot n−n_{CSI-ref} for the reception of the SSB resources associated with the triggered CSI report. Because frequency #2 is different from frequency #1, the UE requires a first RF switching gap to switch its DL RF to frequency #2 to receive the SSB resources associated with the triggered CSI report and optionally a second RF switching gap to switch its UL RF to frequency #1 to transmit the CSI report including the measurement results, if the UL RF is changed due to the change of the DL RF.

As shown in FIG. 2, the first RF switching gap, e.g., switchingTimeDL, is located before the CSI reference resource DL slot n−n_{CSI-ref}, and the second RF switching gap, e.g., switchingTimeUL, is located after the end of the CSI reference resource DL slot n−n_{CSI-ref}.

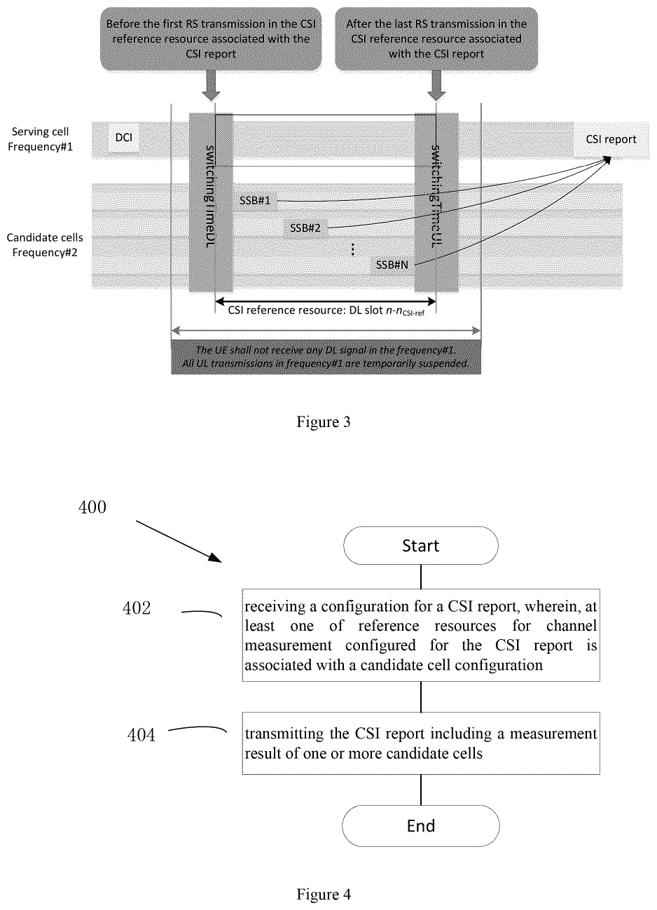

FIG. 3 illustrates another example for CSI measurement and report for Scenario #2 in LTM according to the second sub-embodiment. FIG. 3 differs from FIG. 2 in the location of the RF switching gaps. As shown in FIG. 3, the first RF switching gap, e.g., switchingTimeDL, is located before a first symbol of reception of a first SSB (e.g., SSB #1) in the CSI reference resource DL slot n−CSI-ref and the optional second RF switching gap, e.g., switchingTimeUL, is located after a last symbol of reception of a last SSB (e.g., SSB #N) in the CSI reference resource DL slot n−n_{CSI-ref}.

During the time duration in which the UE receives the SSB or CSI-RS resources configured for the CSI report in frequency #2 and the RF switching gap (including both the first RF switching gap and the second RF switching gap), the UE shall not receive any DL signal in any serving cell in frequency #1, and all the UL transmission in the serving cells in frequency #1 may be temporarily suspended.

The SSB or CSI-RS resources configured in CMR of a CSI report for LTM may be associated with different candidate cells. To avoid frequent RF switching, the second sub-embodiment proposes that all the SSB or CSI-RS resources configured in the CMR for a CSI report for LTM are in a same frequency. On the other hand, each RS may have the same SCS or a different SCS.

FIG. 4 is a schematic flow chart diagram illustrating an embodiment of a method 400 according to the present application. In some embodiments, the method 400 is performed by an apparatus, such as a remote unit (e.g. UE). In certain embodiments, the method 400 may be performed by a processor executing program code, for example, a microcontroller, a microprocessor, a CPU, a GPU, an auxiliary processing unit, a FPGA, or the like.

The method 400 is a method performed at a UE, comprising: 402 receiving a configuration for a CSI report, wherein, at least one of reference resources for channel measurement configured for the CSI report is associated with a candidate cell configuration; and 404 transmitting the CSI report including a measurement result of one or more candidate cells.

In some embodiment, the method further comprises reporting a value of RF switching gap for each frequency or band combination for LTM.

In some embodiment, the method further comprises receiving a configuration to configure a first RF switching gap and/or a second RF switching gap when the frequency of the reference resources for the CSI report is different from the frequency of any BWP of the serving cell. Each of the first RF switching gap and the second RF switching gap may be configured as a number of symbols with reference to SCS of the active BWP of the serving cell configuring or triggering the CSI report or of the BWP in which the CSI report is transmitted.

In some embodiment, each candidate cell configuration configures the parameters including at least one of center frequency of the SSB; subcarrier spacing of the SSB; subframe offset of candidate cell; periodicity of the SSB; SSB positions in a SSB burst; and transmit power of the SSB. When CSI-RS resources are configured as the reference resources, each candidate cell configuration may further configure one or more CSI-RS resources, or one or more CSI-RS resource set, each of which includes one or more CSI-RS resources, for LTM and configure the parameters for each CSI-RS resource including at least one of center frequency of the CSI-RS resource; subcarrier spacing of the CSI-RS resource; periodicity and slot offset of the periodic CSI-RS resource; QCL information of the CSI-RS resource; first OFDM symbol in the slot for transmission of the CSI-RS resource; RE position of the CSI-RS resource in a PRB; sequence for CSI-RS resource sequence initialization; density of the CSI-RS resource; transmit power offset of the CSI-RS resource relative to the transmit power of the SSB in the same candidate cell; and bandwidth of the CSI-RS resource, wherein, each CSI-RS resource is assumed to be a single-port CSI-RS resource.

In some embodiment, all the reference resources configured for the CSI report are in the same frequency.

In some embodiment, when the frequency of reference resources configured for the CSI report is covered by one or more configured BWPs of at least one serving cell, all the reference resources configured for the CSI report have the same SCS.

In some embodiment, when the frequency of reference resources configured for the CSI report are covered by one or more configured BWPs of at least one serving cell, the method further comprises receiving a BWP switching command to switch DL RF of the UE to a BWP that covers the frequency of reference resources configured for the CSI report before receiving a first symbol of a first reference resource configured for the CSI report, wherein, the BWP has the same SCS as the SCS of the reference resources configured for the CSI report.

In some embodiment, the first RF switching gap is located before a DL slot determined as the CSI reference resource associated with the CSI report, and the second RF switching gap is located after the DL slot. In some other embodiment, the first RF switching gap is located before a first symbol of a first reference resource configured for the CSI report, and the second RF switching gap is located after a last symbol of a last reference resource configured for the CSI report.

FIG. 5 is a schematic flow chart diagram illustrating an embodiment of a method 500 according to the present application. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may comprise 502 transmitting a configuration for a CSI report, wherein, at least one of reference resources for channel measurement configured for the CSI report is associated with a candidate cell configuration; and 504 receiving the CSI report including a measurement result of one or more candidate cells.

In some embodiment, the method further comprises receiving a value of RF switching gap for each frequency or band combination for LTM.

In some embodiment, the method further comprises transmitting a configuration to configure a first RF switching gap and/or a second RF switching gap when the frequency of the reference resources for the CSI report is different from the frequency of any BWP of the serving cell. Each of the first RF switching gap and the second RF switching gap may be configured as a number of symbols with reference to SCS of the active BWP of the serving cell configuring or triggering the CSI report or of the BWP in which the CSI report is transmitted.

In some embodiment, each candidate cell configuration configures the parameters including at least one of center frequency of the SSB; subcarrier spacing of the SSB; subframe offset of candidate cell; periodicity of the SSB; SSB positions in a SSB burst; and transmit power of the SSB. When CSI-RS resources are configured as the reference resources, each candidate cell configuration may further configure one or more CSI-RS resources, or one or more CSI-RS resource set, each of which includes one or more CSI-RS resources, for LTM and configure the parameters for each CSI-RS resource including at least one of center frequency of the CSI-RS resource; subcarrier spacing of the CSI-RS resource; periodicity and slot offset of the periodic CSI-RS resource; QCL information of the CSI-RS resource; first OFDM symbol in the slot for transmission of the CSI-RS resource; RE position of the CSI-RS resource in a PRB; sequence for CSI-RS resource sequence initialization; density of the CSI-RS resource; transmit power offset of the CSI-RS resource relative to the transmit power of the SSB in the same candidate cell; and bandwidth of the CSI-RS resource, wherein, each CSI-RS resource is assumed to be a single-port CSI-RS resource.

In some embodiment, all the reference resources configured for the CSI report are in the same frequency.

In some embodiment, when the frequency of reference resources configured for the CSI report is covered by one or more configured BWPs of at least one serving cell, all the reference resources configured for the CSI report have the same SCS.

In some embodiment, when the frequency of reference resources configured for the CSI report are covered by one or more configured BWPs of at least one serving cell, the method further comprises transmitting a BWP switching command to switch DL RF of the UE to a BWP that covers the frequency of reference resources configured for the CSI report before receiving a first symbol of a first reference resource configured for the CSI report, wherein, the BWP has the same SCS as the SCS of the reference resources configured for the CSI report.

In some embodiment, the first RF switching gap is located before a DL slot determined as the CSI reference resource associated with the CSI report, and the second RF switching gap is located after the DL slot. In some other embodiment, the first RF switching gap is located before a first symbol of a first reference resource configured for the CSI report, and the second RF switching gap is located after a last symbol of a last reference resource configured for the CSI report.

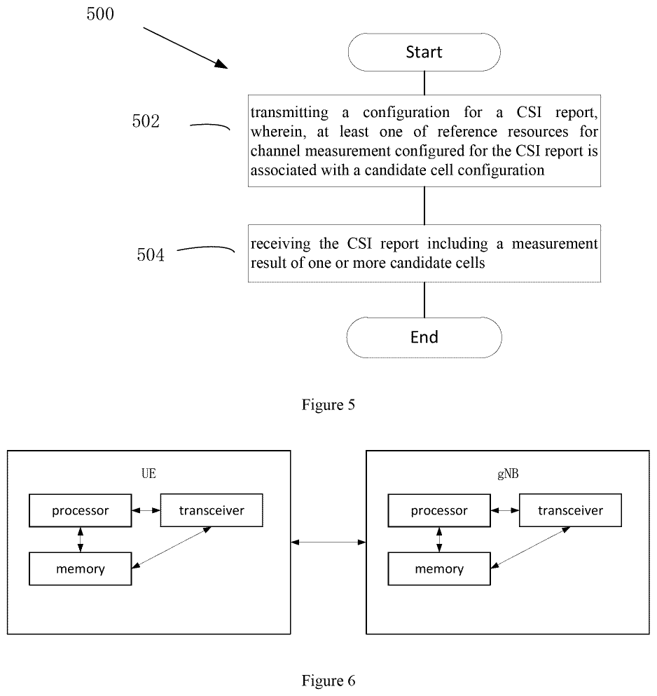

FIG. 6 is a schematic block diagram illustrating apparatuses according to one embodiment.

Referring to FIG. 6, the UE (i.e. the remote unit) includes a processor, a memory, and a transceiver. The processor implements a function, a process, and/or a method which are proposed in FIG. 4.

The UE comprises a transceiver; and a processor coupled to the transceiver, wherein the processor is configured to receive, via the transceiver, a configuration for a CSI report, wherein, at least one of reference resources for channel measurement configured for the CSI report is associated with a candidate cell configuration; and transmit, via the transceiver, the CSI report including a measurement result of one or more candidate cells.

In some embodiment, the processor is further configured to report, via the transceiver, a value of RF switching gap for each frequency or band combination for LTM.

In some embodiment, the processor is further configured to receive, via the transceiver, a configuration to configure a first RF switching gap and/or a second RF switching gap when the frequency of the reference resources for the CSI report is different from the frequency of any BWP of the serving cell. Each of the first RF switching gap and the second RF switching gap may be configured as a number of symbols with reference to SCS of the active BWP of the serving cell configuring or triggering the CSI report or of the BWP in which the CSI report is transmitted.

In some embodiment, each candidate cell configuration configures the parameters including at least one of center frequency of the SSB; subcarrier spacing of the SSB; subframe offset of candidate cell; periodicity of the SSB; SSB positions in a SSB burst; and transmit power of the SSB. When CSI-RS resources are configured as the reference resources, each candidate cell configuration may further configure one or more CSI-RS resources, or one or more CSI-RS resource set, each of which includes one or more CSI-RS resources, for LTM and configure the parameters for each CSI-RS resource including at least one of center frequency of the CSI-RS resource; subcarrier spacing of the CSI-RS resource; periodicity and slot offset of the periodic CSI-RS resource; QCL information of the CSI-RS resource; first OFDM symbol in the slot for transmission of the CSI-RS resource; RE position of the CSI-RS resource in a PRB; sequence for CSI-RS resource sequence initialization; density of the CSI-RS resource; transmit power offset of the CSI-RS resource relative to the transmit power of the SSB in the same candidate cell; and bandwidth of the CSI-RS resource, wherein, each CSI-RS resource is assumed to be a single-port CSI-RS resource.

In some embodiment, all the reference resources configured for the CSI report are in the same frequency.

In some embodiment, when the frequency of reference resources configured for the CSI report is covered by one or more configured BWPs of at least one serving cell, all the reference resources configured for the CSI report have the same SCS.

In some embodiment, when the frequency of reference resources configured for the CSI report are covered by one or more configured BWPs of at least one serving cell, the processor is further configured to receive, via the transceiver, a BWP switching command to switch DL RF of the UE to a BWP that covers the frequency of reference resources configured for the CSI report before receiving, via the transceiver, a first symbol of a first reference resource configured for the CSI report, wherein, the BWP has the same SCS as the SCS of the reference resources configured for the CSI report.

In some embodiment, the first RF switching gap is located before a DL slot determined as the CSI reference resource associated with the CSI report, and the second RF switching gap is located after the DL slot. In some other embodiment, the first RF switching gap is located before a first symbol of a first reference resource configured for the CSI report, and the second RF switching gap is located after a last symbol of a last reference resource configured for the CSI report.

The gNB (i.e. the base unit) includes a processor, a memory, and a transceiver. The processor implements a function, a process, and/or a method which are proposed in FIG. 5.

The base unit comprises a transceiver; and a processor coupled to the transceiver, wherein the processor is configured to transmit, via the transceiver, a configuration for a CSI report, wherein, at least one of reference resources for channel measurement configured for the CSI report is associated with a candidate cell configuration; and receive, via the transceiver, the CSI report including a measurement result of one or more candidate cells.

In some embodiment, the processor is further configured to receive, via the transceiver, a value of RF switching gap for each frequency or band combination for LTM.

In some embodiment, the processor is further configured to transmit, via the transceiver, a configuration to configure a first RF switching gap and/or a second RF switching gap when the frequency of the reference resources for the CSI report is different from the frequency of any BWP of the serving cell. Each of the first RF switching gap and the second RF switching gap may be configured as a number of symbols with reference to SCS of the active BWP of the serving cell configuring or triggering the CSI report or of the BWP in which the CSI report is transmitted.

In some embodiment, each candidate cell configuration configures the parameters including at least one of center frequency of the SSB; subcarrier spacing of the SSB; subframe offset of candidate cell; periodicity of the SSB; SSB positions in a SSB burst; and transmit power of the SSB. When CSI-RS resources are configured as the reference resources, each candidate cell configuration may further configure one or more CSI-RS resources, or one or more CSI-RS resource set, each of which includes one or more CSI-RS resources, for LTM and configure the parameters for each CSI-RS resource including at least one of center frequency of the CSI-RS resource; subcarrier spacing of the CSI-RS resource; periodicity and slot offset of the periodic CSI-RS resource; QCL information of the CSI-RS resource; first OFDM symbol in the slot for transmission of the CSI-RS resource; RE position of the CSI-RS resource in a PRB; sequence for CSI-RS resource sequence initialization; density of the CSI-RS resource; transmit power offset of the CSI-RS resource relative to the transmit power of the SSB in the same candidate cell; and bandwidth of the CSI-RS resource, wherein, each CSI-RS resource is assumed to be a single-port CSI-RS resource.

In some embodiment, all the reference resources configured for the CSI report are in the same frequency.

In some embodiment, when the frequency of reference resources configured for the CSI report is covered by one or more configured BWPs of at least one serving cell, all the reference resources configured for the CSI report have the same SCS.

In some embodiment, when the frequency of reference resources configured for the CSI report are covered by one or more configured BWPs of at least one serving cell, the processor is further configured to transmit, via the transceiver, a BWP switching command to switch DL RF of the UE to a BWP that covers the frequency of reference resources configured for the CSI report before receiving, via the transceiver, a first symbol of a first reference resource configured for the CSI report, wherein, the BWP has the same SCS as the SCS of the reference resources configured for the CSI report.

In some embodiment, the first RF switching gap is located before a DL slot determined as the CSI reference resource associated with the CSI report, and the second RF switching gap is located after the DL slot. In some other embodiment, the first RF switching gap is located before a first symbol of a first reference resource configured for the CSI report, and the second RF switching gap is located after a last symbol of a last reference resource configured for the CSI report.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a configuration for a channel state information (CSI) report, wherein one or more reference resources for channel measurement configured for the CSI report are associated with a candidate cell configuration; and
transmit the CSI report including a measurement result of one or more candidate cells.

2. The UE of claim 1, wherein
the at least one processor is further configured to cause the UE to report a value of a radio frequency (RF) switching gap for each frequency or band combination for L1/L2 triggered mobility (LTM).

3. The UE of claim 1, wherein
the at least one processor is further configured to cause the UE to receive a configuration to configure a first radio frequency (RF) switching gap or a second RF switching gap when a frequency of the one or more reference resources for the CSI report is different from a frequency of any bandwidth partition (BWP) of a serving cell.

4. The UE of claim 3, wherein
the first RF switching gap and the second RF switching gap is configured as a number of symbols with reference to a subcarrier spacing (SCS) of an active BWP of the serving cell configuring or triggering the CSI report, or of a BWP in which the CSI report is transmitted.

5. The UE of claim 1, wherein
each candidate cell configuration configures parameters including:
a center frequency of a synchronization signal block (SSB);
a subcarrier spacing of the SSB;
a subframe offset of a candidate cell;
a periodicity of the SSB;
SSB positions in a SSB burst; or
a transmit power of the SSB.

6. The UE of claim 5, wherein,
when CSI reference signal (CSI-RS) resources are configured as the one or more reference resources, each candidate cell configuration further configures one or more CSI-RS resources, or one or more CSI-RS resource sets, each of which includes one or more CSI-RS resources, for L1/L2 triggered mobility (LTM) and configures parameters for each CSI-RS resource, including:
a center frequency of the CSI-RS resource;
a subcarrier spacing of the CSI-RS resource;
a periodicity and slot offset of a periodic CSI-RS resource;
quasi co-location (QCL) information of the CSI-RS resource;
a first orthogonal frequency-division multiplexing (OFDM) symbol in a slot for transmission of the CSI-RS resource;
a resource element (RE) position of the CSI-RS resource in a physical resource block (PRB);
a sequence for CSI-RS resource sequence initialization;
a density of the CSI-RS resource;
a transmit power offset of the CSI-RS resource relative to the transmit power of the SSB in a same candidate cell;
a bandwidth of the CSI-RS resource,
wherein each CSI-RS resource is a single-port CSI-RS resource.

7. The UE of claim 1, wherein
the one or more reference resources configured for the CSI report are in a same frequency.

8. The UE of claim 1, wherein,
when a frequency of the one or more reference resources configured for the CSI report is covered by one or more configured bandwidth partitions (BWPs) of at least one serving cell, the one or more reference resources configured for the CSI report have a same subcarrier spacing (SCS).

9. The UE of claim 1, wherein,
when a frequency of the one or more reference resources configured for the CSI report are covered by one or more configured bandwidth partitions (BWPs) of at least one serving cell, the at least one processor is further configured to cause the UE to receive, via the transceiver, a BWP switching command to switch a downlink (DL) radio frequency (RF) of the UE to a BWP that covers the frequency of one or more reference resources configured for the CSI report before receiving a first symbol of a first reference resource configured for the CSI report, wherein the BWP has a same subcarrier spacing (SCS) as the SCS of the one or more reference resources configured for the CSI report.

10. The UE of claim 3, wherein
the first RF switching gap is located before a downlink (DL) slot determined as a CSI reference resource associated with the CSI report, and the second RF switching gap is located after the DL slot.

11. The UE of claim 3, wherein
the first RF switching gap is located before a first symbol of a first reference resource configured for the CSI report, and the second RF switching gap is located after a last symbol of a last reference resource configured for the CSI report.

12. A method performed at a user equipment (UE), the method comprising:
receiving a configuration for a channel state information (CSI) report, wherein one or more reference resources for channel measurement configured for the CSI report are associated with a candidate cell configuration; and
transmitting the CSI report including a measurement result of one or more candidate cells.

13. A base unit for wireless communication, comprising:
at least one memory; and
at least one processor coupled with the at least one memory and configured to cause the base unit to:
transmit a configuration for a channel state information (CSI) report, wherein one or more reference resources for channel measurement configured for the CSI report are associated with a candidate cell configuration; and
receive the CSI report including a measurement result of one or more candidate cells.

14. A processor for wireless communication, comprising:
at least one controller coupled with at least one memory and configured to cause the processor to:
receive a configuration for a channel state information (CSI) report, wherein one or more reference resources for channel measurement configured for the CSI report are associated with a candidate cell configuration; and
transmit the CSI report including a measurement result of one or more candidate cells.

15. The processor of claim 14, wherein the at least one controller is further configured to cause the processor to report a value of a radio frequency (RF) switching gap for each frequency or band combination for L1/L2 triggered mobility (LTM).

16. The processor of claim 14, wherein the at least one controller is further configured to cause the processor to receive a configuration to configure a first radio frequency (RF) switching gap or a second RF switching gap when a frequency of the one or more reference resources for the CSI report is different from a frequency of any bandwidth partition (BWP) of a serving cell.

17. The processor of claim 16, wherein the first RF switching gap and the second RF switching gap is configured as a number of symbols with reference to a subcarrier spacing (SCS) of an active BWP of the serving cell configuring or triggering the CSI report, or of a BWP in which the CSI report is transmitted.

18. The processor of claim 16, wherein the first RF switching gap is located before a downlink (DL) slot determined as a CSI reference resource associated with the CSI report, and the second RF switching gap is located after the DL slot.

19. The processor of claim 16, wherein the first RF switching gap is located before a first symbol of a first reference resource configured for the CSI report, and the second RF switching gap is located after a last symbol of a last reference resource configured for the CSI report.

20. The processor of claim 14, wherein, when a frequency of the one or more reference resources configured for the CSI report is covered by one or more configured bandwidth partitions (BWPs) of at least one serving cell, the one or more reference resources configured for the CSI report have a same subcarrier spacing (SCS).
